(19) United States
(12) Patent Application Publication
(10) Pub. No.: US 2017/0217190 A1
(43) Pub. Date: Aug. 3, 2017

(54) Printer, and Control Method of a Printer

(71) Applicant: Seiko Epson Corporation, Tokyo (JP)

(72) Inventor: Minoru Nagaoka, Yamagata-mura (JP)

(21) Appl. No.: 15/407,467

(22) Filed: Jan. 17, 2017

(30) Foreign Application Priority Data
Jan. 29, 2016 (JP) 2016-015318

(51) Int. Cl. B41J 2/165

(52) U.S. Cl. CPC B41J 2/16517

(57) ABSTRACT

A printer enables a user that commands a cleaning operation to know the cost for the ink used in the cleaning operation. A printer 2 has a printhead 7, a head maintenance mechanism 41 for cleaning the printhead 7, and a controller 60. The controller 60 determines whether or not the cleaning is cleaning commanded by an operator, and if the cleaning is cleaning commanded by the operator, displays the ink cost corresponding to the amount of ink used for the cleaning.

This application claims priority under 35 U.S.C. §119 to Japanese Patent Application No. 2016-015318, filed on Jan. 29, 2016, the entire disclosure of which is expressly incorporated by reference herein.

### BACKGROUND

1. Technical Field

The present invention relates to a printer, and a control method of a printer, that performs a cleaning operation such as a flushing operation that discharges ink droplets from a printhead.

2. Related Art

Printers having an inkjet head as the printhead perform a flushing operation to discharge ink droplets of a specific amount of ink from the printhead each time a specific time passes in the printing operation. Such printers also perform an ink suction operation that suctions a specific amount of ink from the printhead when the printer power turns on and when an ink cartridge is replaced. Printers avoid ink nozzle clogging and maintain print quality by automatically performing cleaning operations such as the flushing operation and ink suction operation.

JP-A-2010-184371 describes a printer that charges the user for the amount of ink used. JP-A-2010-184371 describes distributing the ink cost for the amount of ink used in the cleaning operation proportionally to the amount of ink used in the print jobs of each use, thereby distributing the cost among the many users.

The user may also manually make the printer run the cleaning operation by an operation on the operating unit of the printer. The cost of the ink used in the cleaning operation may be charged to the user that made the printer run the cleaning operation. When charged in this way, however, the user may be inconvenienced if the user is not informed of the amount charged (the cost of the ink used).

### SUMMARY

An objective of the invention is to provide a printer, and a control method of a printer, enabling a user that causes a printer to execute a cleaning operation to know the ink cost for the ink used in the cleaning operation.

To achieve the foregoing objective, a printer according to at least one embodiment of the invention has a printhead, a maintenance mechanism for cleaning the printhead, and a controller that controls the printhead and the maintenance mechanism. The controller controls the maintenance mechanism to clean the printhead; determines whether or not the cleaning is cleaning commanded by an operator; and if the cleaning is cleaning commanded by the operator, calculates an ink cost corresponding to the amount of ink used for the cleaning, and displays the ink cost.

This configuration displays the cost of the ink used in the cleaning operation if the cleaning operation was initiated by the operator. The operator (user) can therefore know the ink cost incurred by the cleaning operation.

Preferably in another aspect of the invention, the controller determines the cleaning is cleaning commanded by the operator if the cleaning is executed based on a cleaning command received from an external device.

For example, if the cleaning command was sent by a host device that supplies print data to the printer, the cleaning command was sent to the printer by the operator operating the host device. Therefore, if a cleaning command was received from an external device, the cleaning command was input by an operator, and the cost display displays the ink cost.

In this case, the controller preferably sends information indicating the ink cost shown in the display to the external device. This enables also displaying the ink cost on the external device.

A printer according to another aspect of the invention preferably also has an operating unit (operation part) configured to receive operations by the operator; and the controller, when the cleaning is cleaning based on an operation received by the operating unit, can determine the cleaning was commanded by the operator.

More specifically, operation of the operating unit is by the operator (user). Therefore, if the cleaning command was input from the operating unit, the cost display displays the ink cost.

A printer according to another aspect of the invention preferably also has a display; and the controller controls the display to display the ink cost on the display.

This configuration enables the operator to easily know the ink cost.

Further preferably, the controller, when the cleaning is determined to be cleaning commanded by the operator, displays information indicating the cost of ink used in the cleaning is for invoicing.

This configuration enables the operator to know that the cost of the ink used in the cleaning operation will be charged.

Further preferably in another aspect of the invention, the controller, when cleaning commanded by the operator is executed, calculates the cumulative total ink cost, and displays the total ink cost.

This configuration enables the operator to know the total ink cost incurred by multiple cleaning operations the operator caused the printer to execute.

In another aspect of the invention, the controller preferably executes a cleaning operation when a predetermined set time has past during a printing operation printing print data, and does not consider this cleaning operation to be a cleaning initiated by the operator. In this case, because the cleaning is performed regularly during the printing operation, ink nozzle clogging can be avoided, and print quality maintained. Scheduled cleaning operations that are executed automatically by the printer can also be excluded from invoicing.

As a cleaning operation, the controller may also drive the printhead to discharge a predetermined set amount of ink from the printhead. In other words, the cleaning operation may be a flushing operation.

Another aspect of the invention is a control method of a printer for controlling a maintenance mechanism to clean the printhead, the control method including: determining whether or not the cleaning is cleaning commanded by an operator; and if the cleaning is cleaning commanded by the operator, calculates an ink cost corresponding to the amount of ink used for the cleaning, and displays the ink cost.

When a printhead cleaning operation is executed based on an operator command, the cost of the ink used in the cleaning operation is displayed. As a result, the operator (user) can know the ink cost incurred by the cleaning operation.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 illustrates a printing system including a printer according to at least one embodiment of the invention.

FIG. 2 illustrates the configuration of the printer.

FIG. 3 illustrates the configuration of the printer.

FIG. 4 is a block diagram of the control system of the printing system.

FIG. 5 is a flow chart of the printing operation.

### DESCRIPTION OF EMBODIMENTS

A preferred embodiment of a printer according to at least one embodiment of the invention is described below with reference to the accompanying figures.

### General Configuration

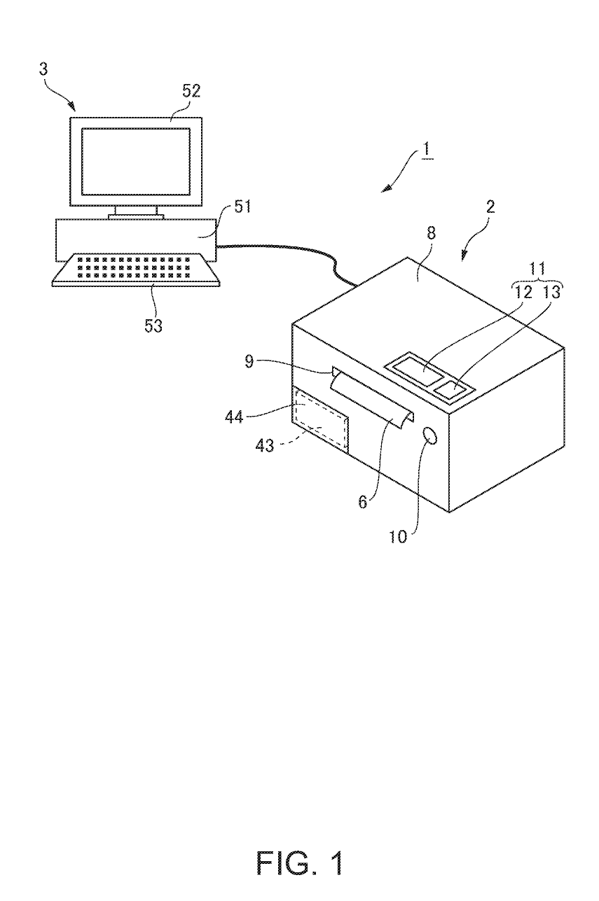

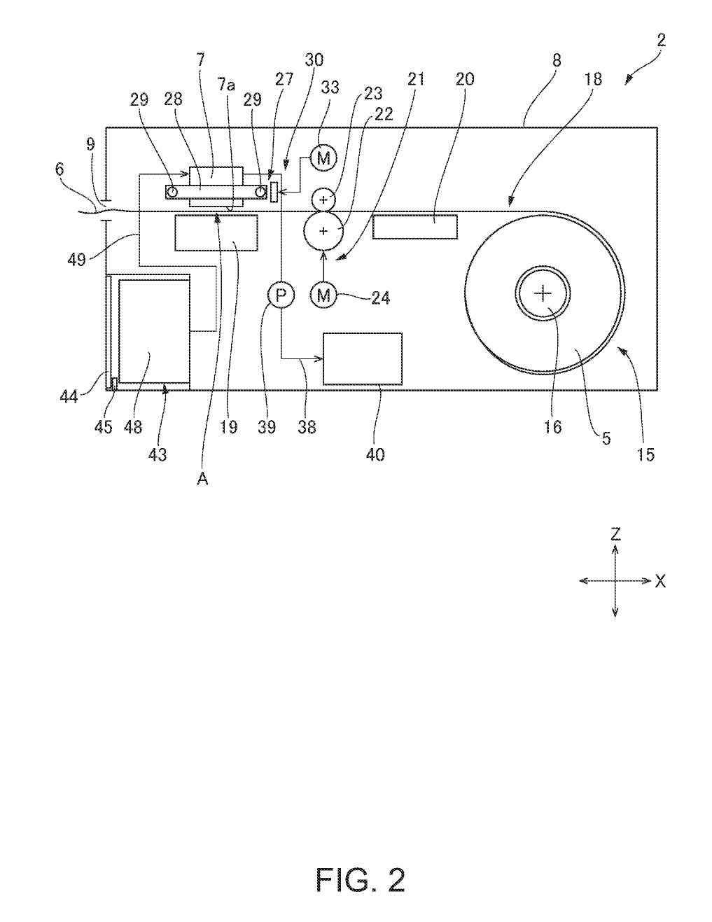

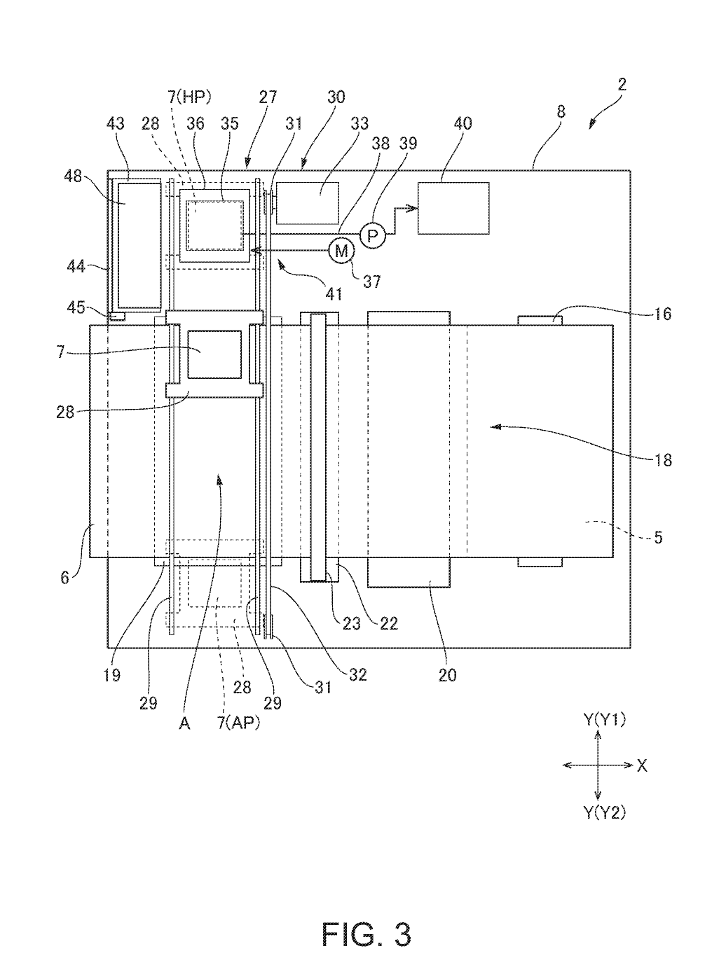

FIG. 1 illustrates a printing system including a printer according to at least one embodiment of the invention. FIG. 2 and FIG. 3 illustrate the configuration of the printer. FIG. 2 is a side view of the printer. FIG. 3 is a plan view of the printer from above. As shown in FIG. 1, the printing system 1 has a printer 2, and a host device 3 communicatively connected to the printer 2.

As shown in FIG. 2, the printer 2 is a roll paper printer that prints on continuous recording paper 6 delivered from a paper roll 5. The printer 2 is an inkjet printer having an inkjet head as the printhead 7. As shown in FIG. 1, the printer 2 has a box-like case 8. A paper exit 9 is in the front of the case 8. A power switch 10 is disposed beside the paper exit 9. An operating panel 11 is on top of the case 8. The operating panel 11 includes a display 12 and an operating member 13.

As shown in FIG. 2, the printhead 7 is located near the paper exit 9 inside the case 8. At the inside back of the case 8 is a roll paper compartment 15 where a paper roll 5 is held. The roll paper compartment 15 has a spindle 16 that supports the paper roll 5. The printer 2 is described below with reference to three mutually perpendicular axes, a longitudinal axis X, transverse axis Y, and vertical axis Z. The front of the printer 2 on the longitudinal axis X is the side where the paper exit 9 is located, and the back is the wide where the roll paper compartment 15 is located. The transverse axis Y is the axial direction of the spindle 16.

Also inside the case 8 is configured a paper conveyance path 18 going from the roll paper compartment 15, past the printing position A of the printhead 7, to the paper exit 6. The printing position A is defined by the ink nozzle face 7a of the printhead 7 and a platen 19 disposed at an opposing position. The paper conveyance path 18 is defined by the platen 19, and a lower paper guide 20 located behind the platen 19. The platen 19 and lower paper guide 20 are above the spindle 16. The platen 19 and lower paper guide 20 are also in front of the spindle 16.

The recording paper 6 is conveyed through the paper conveyance path 18 by a conveyance mechanism 21. The conveyance mechanism 21 includes a conveyance roller 22, and a pressure roller 23 that is pressed from above against the conveyance roller 22 and follows the conveyance roller 22. The conveyance mechanism 21 also has a conveyance motor 24 as the drive source that drives the conveyance roller 22. The conveyance roller 22 is between the platen 19 and lower paper guide 20. The conveyance mechanism 21 holds and conveys the recording paper 6 between the conveyance roller 22 and pressure roller 23.

The printer 2 also has a scanning mechanism 27 that moves the printhead 7 on the transverse axis Y of the printer 2. As shown in FIG. 3, the scanning mechanism 27 includes a carriage 28 that carries the printhead 7, a pair of carriage guide rails 29 parallel to the transverse axis Y, and a carriage moving mechanism 30 that moves the carriage 28 along the carriage guide rails 29.

The carriage moving mechanism 30 includes a pair of pulleys 31 disposed near the ends of the carriage guide rails 29, a timing belt 32 mounted on the pair of pulleys 31, and a carriage motor 33 for driving the pair of pulleys 31. The carriage 28 is connected to the timing belt 32.

When the carriage 28 moves by driving the carriage motor 33, the printhead 7 moves on the transverse axis Y together with the carriage 28. By the carriage 28 being moved by the carriage moving mechanism 30, the printhead 7 moves between a home position HP removed to a first direction Y1 on the transverse axis Y from the paper conveyance path 18, and an away position AP removed from the paper conveyance path 18 to a second direction Y2, which is on the opposite side of the transverse axis Y as the first direction Y1.

As shown in FIG. 3, a head cap 35, and a lift mechanism 36 that moves the head cap 35 vertically, are disposed at the home position HP. The lift mechanism 36 moves the head cap 35 between an up position capping the ink nozzle face 7a of the printhead 7 at the home position HP, and a down position separated from the ink nozzle face 7a. The lift mechanism 36 also has a lift motor 37 as the drive source.

A waste ink path 38 is connected to the head cap 35. The waste ink path 38 communicates by a suction pump 39 with a waste ink tank 40. The head cap 35, lift mechanism 36, waste ink path 38, suction pump 39, and waste ink tank 40 embody a head maintenance mechanism 41.

A cartridge holder 43 is also disposed at one side inside the case 8. As shown in FIG. 1 and FIG. 2, an access door 44 for opening and closing the cartridge holder 43 is disposed below the paper exit 9 at the front of the case 8. At the front inside of the case 8 is also disposed a door detector 45 for detecting opening and closing the access door 44. The door detector 45 in this example mechanically detects the access door 44 when the access door 44 closes the cartridge holder 43. As shown in FIG. 2, when an ink cartridge 48 is installed in the cartridge holder 43, ink in the ink cartridge 48 can be supplied through the ink path 49 to the printhead 7.

As shown in FIG. 1, the host device 3 includes a computer 51, a display 52 connected to the computer 51, and an input device 53 connected to the computer 51. The input device 53 in this example is a keyboard. Print data is supplied from the host device 3 to the printer 2.

### Control System

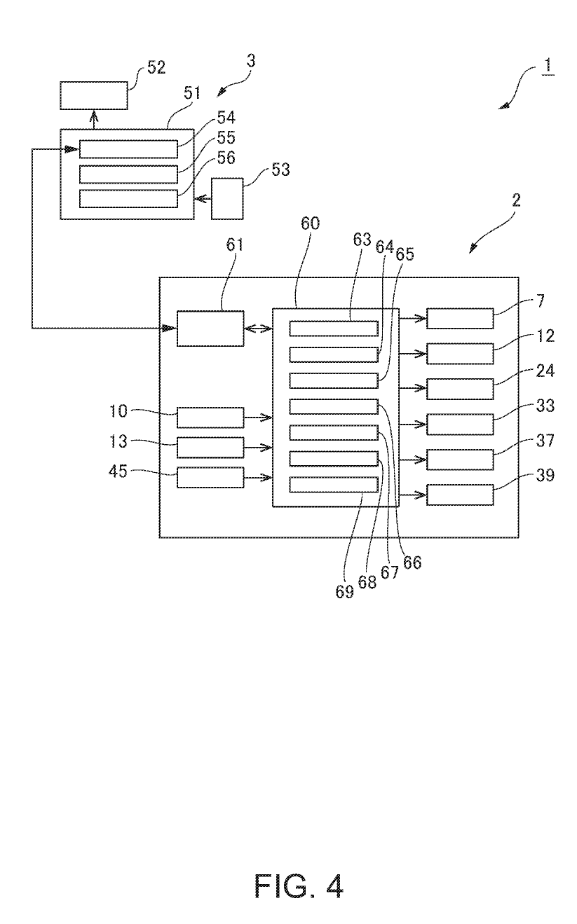

FIG. 4 is a block diagram of the control system of the printing system.

The printer 2 is configured around a controller 60 including a CPU and memory. A communicator 61 for communicating with external devices is connected to the controller 60. To the input side of the controller 60 are connected a power switch 10, the operating member 13, and door detector 45. To the output side of the controller 60 are connected the printhead 7, display 12, conveyance motor 24, carriage motor 33, lift motor 37, and suction pump 39. The controller 60 includes a print controller 63, capping controller 64, cleaning operation controller 65, head suction controller 66, scheduled cleaning controller 67, decision unit 68 (decision part 68), and cost display 69.

When print data is supplied from the host device 3, the print controller 63 drives the conveyance motor 24 (conveyance mechanism 21) to convey the recording paper 6 from the conveyance roller 22 toward the printing position A. When print data is supplied from the host device 3, the print controller 63 also drives the printhead 7 and carriage motor 33 to print on the recording paper 6 passing the printing position A while the printhead 7 scans the transverse axis Y at the printing position A.

While the printer 2 waits for print data from the host device 3, the capping controller 64 moves the printhead 7 to the home position HP. The capping controller 64 then drives the lift motor 37 to move the head cap 35 to the up position, and covers the ink nozzle face 7a of the printhead 7 with the head cap 35. This prevents water in the ink from evaporating from the printhead 7 (ink nozzles). When print data is supplied from the host device 3, the capping controller 64 moves the head cap 35 to the down position, and releases the printhead 7.

If the printhead 7 is not at the home position HP when the printer 2 power is turned off, the capping controller 64 drives the carriage motor 33 and moves the printhead 7 to the home position HP. The capping controller 64 then drives the lift motor 37 to move the head cap 35 to the up position and cover the ink nozzle face 7a of the printhead 7 with the head cap 35.

The cleaning operation controller 65 executes a head suction operation. In the head suction operation, the cleaning operation controller 65 checks that the printhead 7 is at the home position HP, and then raises the head cap 35 to cover the ink nozzle face 7a of the printhead 7. The cleaning operation controller 65 then operates the suction pump 39. As a result, the cleaning operation controller 65 produces negative pressure in the space enclosed by the head cap 35 and ink nozzle face 7a, and discharges a set amount of ink from the printhead 7 into the waste ink tank 40.

The cleaning operation controller 65 also executes a flushing operation. In the flushing operation, the cleaning operation controller 65 checks that the printhead 7 is at the home position HP, and then moves the head cap 35 to a middle position 35C where there is a slight gap to the ink nozzle face 7a of the printhead 7, and then operates the printhead 7. As a result, a set amount of ink is then discharged from the printhead 7 into the head cap 35.

If the cleaning operation controller 65 cannot confirm when starting the cleaning operation that the printhead 7 is at the home position HP, the cleaning operation controller 65 drives the carriage motor 33 to move the printhead 7 to the home position HP. Note that the head suction operation and flushing operation are both examples of printhead 7 cleaning operations.

When the power switch 10 is operated and the printer 2 power turned on, the head suction controller 66 causes the head maintenance mechanism 41 to execute the head suction operation. The head suction controller 66 also causes the head maintenance mechanism 41 to execute the head suction operation when opening and closing the access door 44 of the cartridge holder 43 is detected by the door detector 45. In other words, the head suction controller 66 also causes the head maintenance mechanism 41 to execute the head suction operation when an ink cartridge 48 is replaced.

The scheduled cleaning controller 67 causes the head maintenance mechanism 41 to execute the flushing operation whenever a predetermined set time passes during the printing operation printing print data.

The cleaning operation may be executed in response to operation of the operating member 13. A cleaning command instructing the printer 2 to execute the cleaning operation may also be sent from the host device 3, the cleaning command received by the controller 60 through the communication unit 61 (communicator 61), and the head maintenance mechanism 41 commanded to execute the cleaning operation.

The decision unit 68 determines whether or not cleaning was commanded by the operator. More specifically, if the cleaning operation was executed based on a cleaning command received from the host device 3, the decision unit 68 determines the cleaning operation was commanded by the operator. More specifically, if the controller 60 receives a cleaning command from the host device 3 and the cleaning operation is executed, the operator operated the host device 3 to command the cleaning operation. If the cleaning operation was executed in response to an operation of the operating member 13, the decision unit 68 determines the cleaning operation was commanded by the operator. In this case, the operator commanded the cleaning operation by operating the operating member 13.

Each time one print job printing print data ends, the cost display 69 calculates and displays on the display 12 the ink cost of the ink used to print the print data. The cost display 69 also sends the calculated ink cost to the host device 3, and displays the ink cost on the host device 3 (display 52). Each time one print job ends, the cost display 69 also calculates and displays on the display 12 the total ink cost, which is the sum of the ink costs calculated in the past. The cost display 69 also sends the calculated total ink cost to the host device 3, and displays the total ink cost on the host device 3.

The amount of ink used to print print data is acquired based on the number of shots of ink droplets discharged by the printhead 7 during the printing operation. The ink cost per unit volume is previously set. Therefore, the cost display 69 can calculate the cost of the ink used to print the print data based on the number of shots of ink droplets and the cost of ink per unit volume.

When the cleaning operation was commanded by the operator, the cost display 69 also displays a message that the displayed ink cost is for ink used in the cleaning operation. The cost display 69 also sends to the host device 3 information indicating that the transmitted ink cost is for ink used in the cleaning operation.

Each time a cleaning operation (head suction operation or flushing operation) is executed as commanded by the operator, the cost display 69 also displays on the display 12 the cleaning ink cost (ink cost) for the amount of ink used in the cleaning operation. The cost display 69 also sends the cleaning ink cost to the host device 3, and displays the cleaning ink cost on the host device 3. Each time a cleaning operation ends, the cost display 69 also calculates and displays on the display 12 the total cleaning ink cost, which is the sum of the cleaning ink costs calculated in the past. The cost display 69 also sends the calculated total cleaning ink cost to the host device 3, and displays the total cleaning ink cost on the host device 3.

The amount of ink (specific amount of ink) suctioned and discharged from the printhead 7 in the head suction operation is already known. The amount of ink (specific amount of ink) suctioned and discharged from the printhead 7 in the flushing operation is also already known. The ink cost per unit volume is also already known. As a result, the ink cost incurred by the cleaning operation is already known. The cost display 69 therefore displays the cleaning ink cost when a cleaning operation is executed based on the known cost of ink for the cleaning operation.

Alternatively, each time a cleaning operation is executed, the cost display 69 may calculate and display the cleaning ink cost based on the ink cost per unit volume and the amount of ink used in the cleaning operation.

Each time one print job or cleaning operation ends, the cost display 69 also display on the display 12 the gross cost, which is the sum of the total ink cost and the total cleaning ink cost. The cost display 69 also sends the gross cost to the host device 3, and displays the gross cost on the host device 3.

An operating system (OS), application program, and printer driver program run on the computer 51 of the host device 3. As a result, the host device 3 functions as an OS executor 54, an application executor 55 that generates application data for printing, and a printer driver executor 56 that controls driving the printer 2.

The printer driver executor 56 acquires the application data the application executor 55 generated through the OS executor 54. The printer driver executor 56 generates print data that controls driving the printer 2 from the application data. The printer driver executor 56 sends the print data to the printer 2 to control driving the printer 2. The printer driver executor 56 receives from the printer 2, and displays on the display 52, the total ink cost, the cleaning ink cost, the total cleaning ink cost, and the gross cost. When information indicating that ink used in a cleaning operation is the cost object is received from the printer 2, the printer driver executor 56 displays the information on the display 52.

### Printing Operation

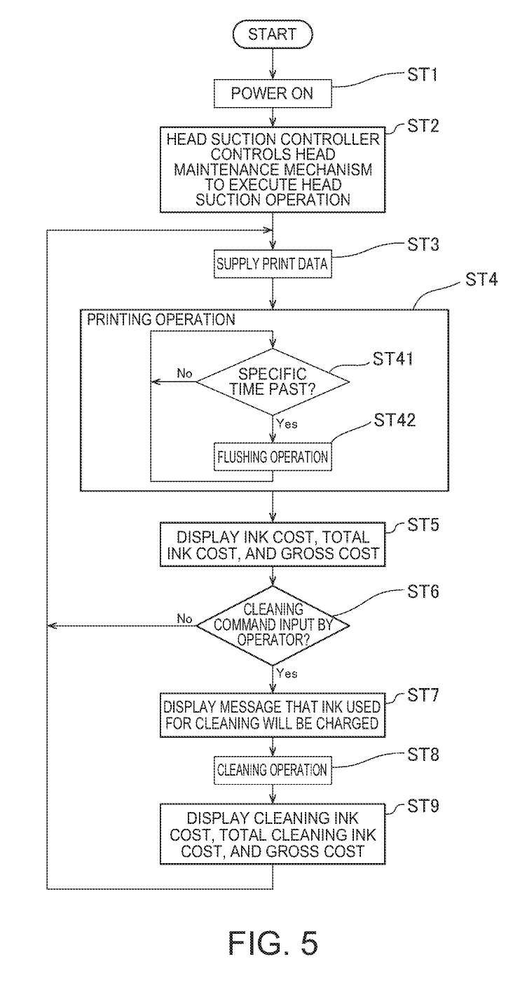

FIG. 5 is a flow chart of the printing operation. When the printer 2 power is off, the printhead 7 is at the home position HP, and the ink nozzle face 7a of the printhead 7 is covered by the head cap 35.

When the power switch 10 is operated and the printer 2 is turned on (step ST1), the head suction controller 66 controls the head maintenance mechanism 41 to execute the head suction operation (step ST2). More specifically, the suction pump 39 is driven, ink is suctioned from the printhead 7, and a specific amount of ink is discharged into the waste ink tank 40.

The head suction operation when the printer power turns on is an operation required to maintain the print quality of the printer 2. Therefore, in this example, the ink used in the head suction operation is not a cost charged to the user. The cost display 69 therefore does not display a cleaning ink cost to be charged to the user, and does not calculate the total cleaning ink cost.

Next, when print data is supplied from the host device 3 (step ST3), the printer 2 executes the printing operation (step ST4). Specifically, the printer 2 drives the lift motor 37 to lower the head cap 35 to the down position and release the printhead 7. Next, the printer 2 drives the conveyance motor 24, and conveys the recording paper 6 through the paper conveyance path 18. The printer 2 also drives the printhead 7 and carriage motor 33 based on the print data, and discharges ink droplets from the printhead 7 while the printhead 7 scans the printing position A.

If a specific time passes during the printing operation (step ST41: Yes), the scheduled cleaning controller 67 drives the head maintenance mechanism 41 to execute the flushing operation (step ST42). In the flushing operation, the printer 2 drives the carriage motor 33 to move the printhead 7 to the home position HP. The printer 2 also drives the printhead 7 to discharge a specific amount of ink from the printhead 7 into the head cap 35.

The flushing operation executed during the printing operation is an operation required to maintain the print quality of the printer 2. Therefore, in this example, the ink used in the flushing operation is not a cost charged to the user. The cost display 69 therefore does not display a cleaning ink cost to be charged to the user, and does not calculate the total cleaning ink cost.

When printing the print data then ends (one print job ends), the printer 2 calculates the ink cost based on the number of shots of ink droplets discharged during the printing operation. The printer 2 also calculates the total ink cost and the gross cost. The printer 2 displays the calculated ink cost, total ink cost, and gross cost on the display 12. The printer 2 also sends the calculated ink cost, total ink cost, and gross cost to the host device 3 for display on the host device 3 (step ST5).

Whether an operator command to execute a cleaning operation was asserted before new print data is supplied is then determined (step ST6). If the operator commanded a cleaning operation, that is, if a cleaning command (head suction command or flushing command) was received from the host device 3, or if a cleaning operation was commanded by operation of the operating member 13 (step ST6: Yes), the printer 2 displays on the display 12 a message that the ink used in the cleaning operation to be performed is an ink cost to be charged to the user. The printer 2 also sends to the host device 3 information indicating that the ink used in the cleaning operation is an ink cost to be charged to the user. Information indicating that the ink used in the cleaning operation is an ink cost to be charged to the user is therefore displayed on the display 52 of the host device 3 (step ST7).

The printer 2 then executes the commanded cleaning operation (head suction operation or flushing operation) (step ST8).

When the cleaning operation ends, the printer 2 displays on the display 12 the cleaning ink cost corresponding to the amount of ink used in the cleaning operation. The printer 2 also calculates and displays on the display 12 the total cleaning ink cost and the gross cost. The printer 2 also sends the cleaning ink cost, total cleaning ink cost, and gross cost to the host device 3. As a result, the cleaning ink cost, total cleaning ink cost, and gross cost are displayed on the display 52 of the host device 3 (step ST9).

When print data is then supplied from the host device 3, the operation of step ST3 to step ST5 is repeated.

This embodiment of the invention enables the operator to easily know the cleaning ink cost incurred by a cleaning operation initiated by the operator. The operator can also easily know the total cleaning ink cost incurred by the cleaning operations initiated by the operator. User convenience is therefore excellent.

Cleaning operations executed automatically by the printer 2 are not included in the charged costs. More specifically, the cost of ink for cleaning operations the printer 2 executes to maintain print quality is not charged to the user. User convenience is therefore excellent.

### OTHER EXAMPLES

The timing of the head suction operation is not limited to the foregoing. For example, if the printer 2 has a mechanism for detecting faulty ink nozzles, and this detection mechanism regularly executes a detection operation to detect faulty nozzles, the head maintenance mechanism 41 may be controlled to execute the head suction operation when, for example, the detected number of faulty ink nozzles exceeds a previously set threshold.

Furthermore, in step ST7 in FIG. 5, the printer 2 (cost display 69) may enable the user to cancel the input cleaning command after displaying on the display 12 information indicating that the user will be charged for the ink used in the cleaning operation. In this case, after displaying on the display 12 information indicating that the user will be charged for the ink used in the cleaning operation, the cost display 69 may display a message such as “Cancel the cleaning operation?” on the display 12 for the operator. The cleaning operation can then be cancelled if a specific operation is detected by the operating member 13 while this message is displayed.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printer comprising:
a printhead; and
a controller configured to clean the printhead,
determine whether or not the cleaning is cleaning commanded by an operator, and
if the cleaning is cleaning commanded by the operator, calculate an ink cost corresponding to the amount of ink used for the cleaning, and display the ink cost.

2. The printer described in claim 1, wherein:
the controller determines the cleaning is cleaning commanded by the operator if the cleaning is executed based on a command received from an external device.

3. The printer described in claim 2, wherein:
the controller sends information indicating the ink cost to the external device.

4. The printer described in claim 1, further comprising:
an operating part configured to receive operations by the operator;
the controller, when the cleaning is based on an operation received by the operating part, determines the cleaning is cleaning commanded by the operator.

5. The printer described in claim 1, further comprising:
a display;
the controller displaying the ink cost on the display.

6. The printer described in claim 1, wherein:
the controller, when the cleaning is determined to be cleaning commanded by the operator, displays information indicating the cost of ink used in the cleaning is for invoicing.

7. The printer described in claim 1, wherein:
the controller, when cleaning commanded by the operator is executed, calculates the cumulative total ink cost, and displays the total ink cost.

8. The printer described in claim 1, wherein:
the controller executes a scheduled cleaning when a predetermined set time has past, and
determines scheduled cleaning to not be cleaning that is commanded by the operator.

9. The printer described in claim 1, wherein:
the cleaning is a flushing operation that discharges a predetermined set amount of ink from the printhead.

10. A control method of a printer that cleans a printhead, comprising:
determining whether or not the cleaning is cleaning commanded by an operator; and
if the cleaning is cleaning commanded by the operator, calculating an ink cost corresponding to the amount of ink used for the cleaning, and displaying the ink cost.

11. The control method of a printer described in claim 10, further comprising:
determining the cleaning is cleaning commanded by the operator if the cleaning is executed based on a command received from an external device.

12. The control method of a printer described in claim 11, further comprising:
sending information indicating the ink cost to the external device.

13. The control method of a printer described in claim 10, wherein:
the printer has an operating part configured to receive operations by the operator;
the control method determining, when the cleaning is based on an operation received by the operating part, that the cleaning is cleaning commanded by the operator.

14. The control method of a printer described in claim 10, further comprising:
displaying, when the cleaning is determined to be cleaning commanded by the operator, information indicating the cost of ink used in the cleaning is for invoicing.

15. The control method of a printer described in claim 10, further comprising:
when cleaning commanded by the operator is executed,
calculating the cumulative total ink cost, and displaying the total ink cost.

16. The control method of a printer described in claim 10, further comprising:
executes a scheduled cleaning when a predetermined set time has past; and
determining scheduled cleaning to not be cleaning that is commanded by the operator.

17. The control method of a printer described in claim 10, wherein:
the cleaning is a flushing operation that discharges a predetermined set amount of ink from the printhead.
